(19) United States
(12) Patent Application Publication
(10) Pub. No.: US 2013/0136889 A1
(43) Pub. Date: May 30, 2013

(54) Adhesive Decal For Facemasks

(71) Applicant: Intentional Facemask LP, Edmond, OK (US)

(72) Inventors: Barry Wade, Edmond, OK (US); Mike Sebourn, Edmond, OK (US); Eric Soukup, Edmond, OK (US)

(73) Assignee: Intentional Facemask LP, Edmond, OK (US)

(21) Appl. No.: 13/749,820

(22) Filed: Jan. 25, 2013

Related U.S. Application Data
(63) Continuation-in-part of application No. 29/340,514, filed on Jul. 20, 2009, now abandoned.
Application No. 29/340,514 is a continuation-in-part of application No. 29/277,240, filed on Feb. 19, 2007, now Pat. No. D598610.

(51) Int. Cl. G09F 7/14

(52) U.S. Cl. CPC G09F 7/14
USPC 428/99; 156/250

(57) ABSTRACT

The present invention is directed to an adhesive decal for use with the facemasks of helmets. The adhesive decal is capable of adhering to at least one of a plurality of posts that make up the facemasks. The sides of the adhesive decal are cut to form a series of repeated patterns. The cut of the adhesive decals allows the decal to adhere to the circumference of the posts without causing or significantly reducing any dimpling or puckering of the adhesive decal.

### CROSS REFERENCE TO RELATED APPLICATIONS

This application is a continuation-in-part of U.S. Design patent application Ser. No. 29/340,514 filed Jul. 20, 2009, which is a continuation-in-part of U.S. Design patent application Ser. No 29/277,240, filed Feb. 19, 2007, now U.S. Pat. No. D598,610, the contents of which are incorporated herein by reference.

### FIELD OF THE INVENTION

The present invention relates to adhesive decals for use with facemask and helmets for the purposes of displaying information.

### SUMMARY OF THE INVENTION

The present invention is directed to an adhesive decal for use with a protective helmet comprising a facemask, the facemask comprising a plurality of posts. The adhesive decal comprises a first side comprising a first repeated pattern, a second side comprising a second repeated pattern corresponding to the first repeated pattern. The adhesive decal is attachable to a circumference of at least one of the plurality of posts of the facemask so that the first repeated pattern is in a mating arrangement with the second repeated pattern.

The present invention is also directed to an adhesive decal for use with a protective helmet comprising a facemask, the facemask comprising a plurality of posts. The adhesive decal comprises a face to display information, a first side of the face comprising a first repeated pattern and a second side of the face comprising a second repeated pattern. The first and second repeated patterns are created by removing portions of the adhesive decal from the first side and the second side. The adhesive decal is attachable to a circumference of at least one of the plurality of posts of the facemask so that the first repeated pattern is in a mating arrangement with the second repeated pattern.

The present invention is further directed to a method for adhering an adhesive decal to a protective helmet comprising a facemask. The method comprises the steps of cutting a repeated pattern into a first side of the adhesive decal, cutting a repeated pattern into a second side of the adhesive decal, and adhering the adhesive decal to a circumference of at least one of a plurality of posts of the facemask; wherein, the face of the adhesive decal is on a front side of the at least one of the plurality of posts, and the first side and the second side of the face extend around the circumference of the at least one of the plurality of posts.

### BRIEF DESCRIPTION OF THE DRAWINGS

FIG. 1 is a right side perspective view of a football helmet having a facemask with an adhesive decal of the present invention on the facemask.

FIG. 2 is a left side perspective view of the football helmet having the adhesive decal on the facemask.

FIG. 3 is a horizontal embodiment of the adhesive decal.

FIG. 4 is a vertical embodiment of the adhesive decal of FIG. 3.

FIG. 5 is a second horizontal embodiment of the adhesive decal.

FIG. 6 is a vertical embodiment of the adhesive decal of FIG. 5.

FIG. 7 is a third horizontal embodiment of the adhesive decal.

FIG. 8 is a vertical embodiment of the adhesive decal of FIG. 7.

FIG. 9 is the horizontal embodiment of the adhesive decal of FIG. 3 with a varied form of an information display.

FIG. 10 is a front view of the football helmet with the vertical embodiment of the adhesive decal on the facemask.

FIG. 11 is a front view of the football helmet with the horizontal embodiment of the adhesive decal on the facemask.

### DETAILED DESCRIPTION OF THE EMBODIMENTS

Many protective helmets used by participants in sporting events, such as football helmets, have adhesive decals on their sides to display information. Such information may include the team's name, the player's name or number, or even advertising information. However, these adhesive decals are typically not placed on the facemask of the helmet. Current adhesive decals on the market are not capable of adhering to the facemask of the helmet without some puckering or dimpling. The puckering or dimpling is caused because the decal must adhere around the circumference of one of the generally curved posts of the facemask. The present invention is an adhesive decal that is capable of adhering to one of the posts of the facemask without puckering or dimpling.

The present invention allows for the display of information on the helmet in addition to displaying information on the sides of the facemask itself. When the user wears the facemask and the user's head and face are displayed on a television broadcast, the information as well as the image of the user's head, face, and helmet is displayed to the viewing audience. In this manner, the information is displayed wherever the video broadcast is displayed. Further, with new technology, such as HD Digital Photographs and high definition television or HDTV, the impact of viewing the information is enhanced due to the resolution and color intensity of the HDTV broadcasting medium, making the adhesive decal easily visible.

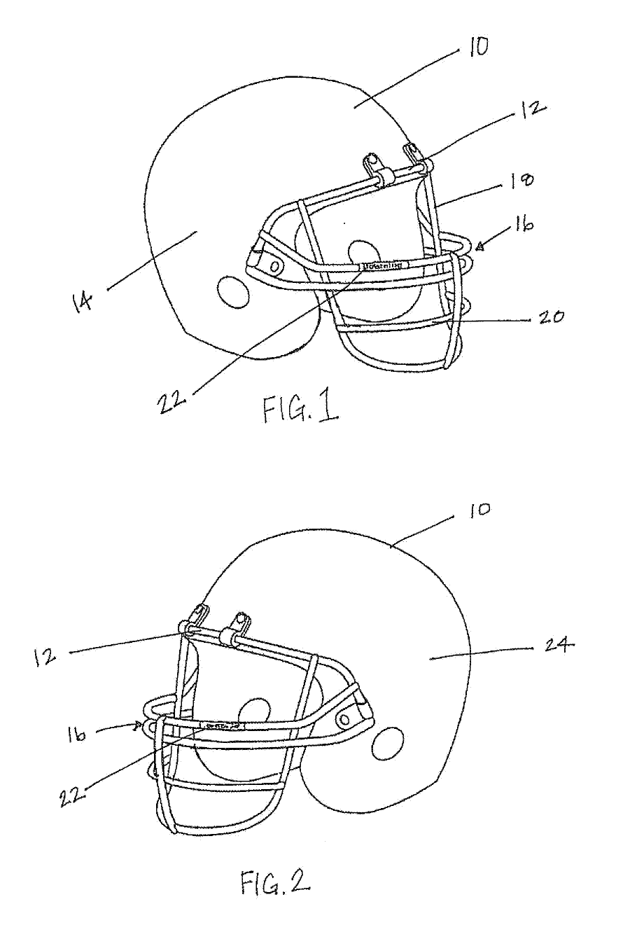

Turning now to the Figures, FIG. 1 is a perspective view of a helmet 10 comprising a facemask 12. FIG. 1 shows a first side 14 of the helmet 10 and the facemask 12. The facemask 12 is any device that is worn to protect the face of a player participating in sporting events. For example, the facemask may include, but is not limited to, the facemask of a football helmet, the facemask of a lacrosse helmet, the facemask of an ice hockey helmet, the facemask on a field hockey helmet, the facemask of a baseball or softball catcher's mask or batting helmet, the facemask on a helmet worn by a jockey, and the facemask worn by basketball players to protect previous facial or dental injuries. The term facemask 12 may also include replica facemasks on miniature memorabilia helmets or any other enlarged or miniature helmets intended to depict or simulate actual helmets.

The facemask 12 comprises a plurality of posts 16. The plurality of posts 16 may comprise a plurality of vertical posts 18, a plurality of horizontal posts 20, and/or any other orientation of the posts 16. Embodiments are not limited to the orientation of the posts 16 shown in FIG. 1. Also shown adhering to one of the horizontal posts 20 in FIG. 1 is an adhesive decal 22 of the present invention. The adhesive decal 22 is attachable to the circumference of at least one of the posts 16 of the facemask 12.

FIG. 2 shows a second side 24 of the helmet 10 and the facemask 12. The adhesive decal 22 is shown adhering to the horizontal post 20. The adhesive decals 22 may adhere to any of the posts 16. As many adhesive decals 22 as desired may adhere to the posts 16 of the facemask 12 at any given time. The adhesive decals 22 may also adhere permanently or temporarily to the posts 16 of the facemask 12.

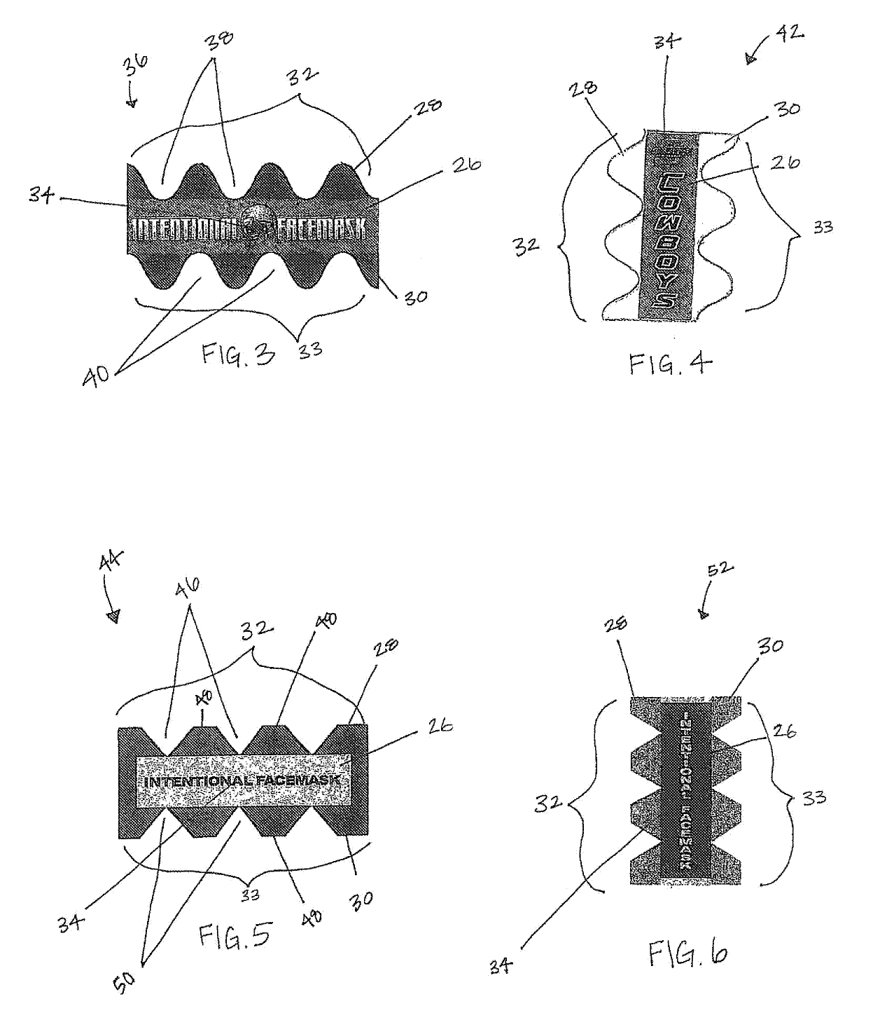

Turning now to FIGS. 3-9, multiple embodiments of the adhesive decal 22 are shown. All of the embodiments of the adhesive decal 22 comprise a face 26. The face 26 comprises a first side 28, a second side 30. The first side 28 comprises a first repeated pattern 32. The second side 30 comprises a second repeated pattern 33. The first repeated pattern 32 corresponds with the second repeated pattern 33. The first and second repeated patterns 32 and 33 are formed by removing a portion of the adhesive decal 22 from both the first and second side 28 and 30 of the face 26. The repeated patterns 32 and 33 vary with the different embodiments so as to form different shaped first and second sides 28 and 30 of the face 26 or different shaped patterns for the face 26.

The face 26 further comprises an information display 34. The information display 34 is defined broadly to comprise any combination of numbers, letter, symbols, graphical displays or the like. For example, the information display may comprise, but is not limited to, markings attributed to the team, patterns, designs, logos, lettering, business names, product names, foreign country names, institutional names, university or college names, abbreviations of university or college names, university or college logos, team logos or insignias, solid patterns or colors, team colors, stripes or patterns, names of individual players, jersey numbers or identification of individual players, informational slogans, and political slogans or information, dates, conference/league rankings, and bowl game information such as “Super Bowl” or a particular college or Bowl Championship Series bowl game, league championship game.

The information display 34 may be affixed to the face 26 by any number of means, For example, such means may include, but is not limited to, stenciling, decaling, painting, engraving, or laser engraving.

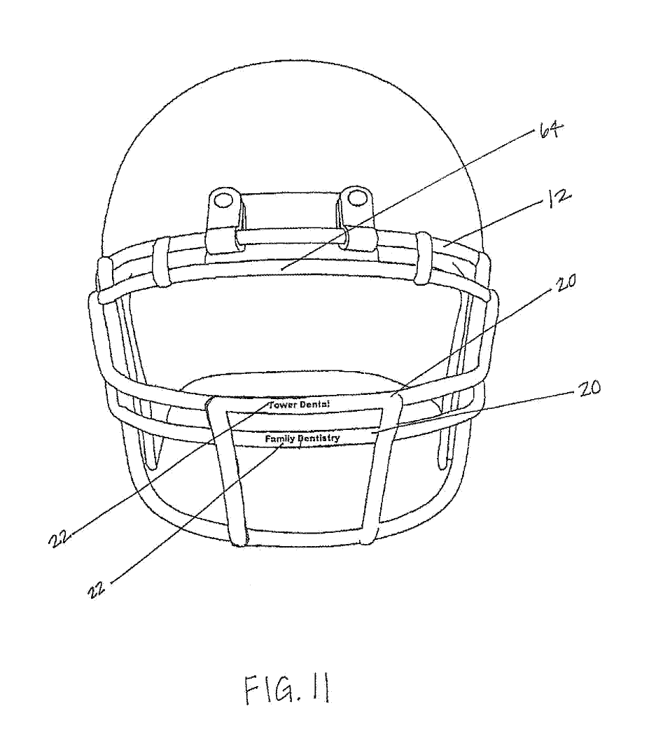

The information display 34 and the face 26 of the adhesive decal 22 may also be a separate color from the first and second side 28 and 30 of the face 26. As seen in FIGS. 3-8, the information display 34 is a different color than the first and second side 28 and 30. The first and second side 28 and 30 are preferably the same color as the posts 16 of the facemask 12 so as to not distract athletes during play. Alternatively, the information display 34 may be the same color as the first and second side 28 and 30, as shown in FIG. 9.

FIG. 3 shows an embodiment 36 of the adhesive decal 22. The first repeated pattern 32 of the embodiment 36 comprises a U-shaped cut 38 cut into the first side 28 of the adhesive decal embodiment 36. The U-shaped cut 38 is repeated such that the first repeated pattern 32 forms a sound wave pattern. The second repeated pattern 33 of the second side 30 comprises an up-side-down U-shaped cut 40. The up-side-down U-shaped cut 40 is repeated such that the second repeated pattern 33 also forms a sound wave pattern. Therefore, the first and second side 28 and 30 or wings of embodiment 36 have no sharp transitions or corners. Having no sharp transitions or corners in the first and second side 28 and 30 or wings of the face 26 has been found to eliminate the dimpling or puckering in the adhesive decal 22 the best. Embodiment 36 shown in FIG. 3 shows the information display 34 displayed horizontally; thus, embodiment 36 will typically be positioned on one of the horizontal posts 20 of the facemask 12.

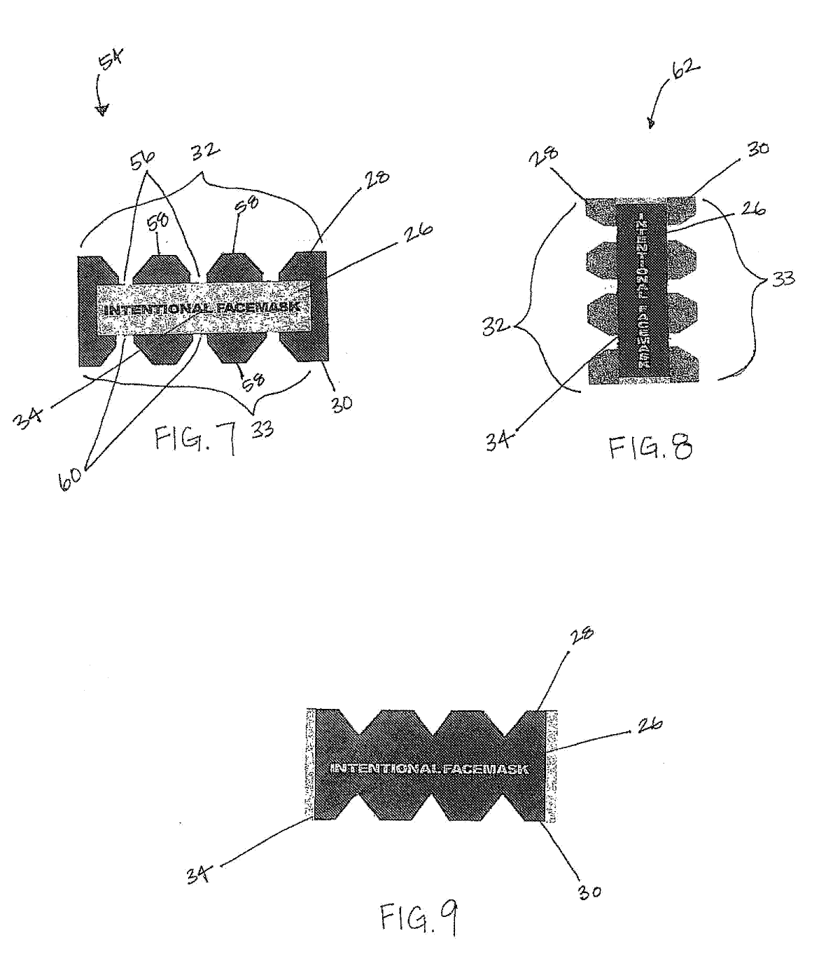

FIG. 4 shows an embodiment 42 of the adhesive decal 22. Embodiment 42 is identical to embodiment 36 shown in FIG. 3, but the information display 34 in embodiment 42 is displayed vertically. Thus, embodiment 42 of the adhesive decal 22 will typically be positioned on one of the vertical posts 18 of the facemask 12.

Turning now to FIG. 5, an embodiment 44 of the adhesive decal 22 is shown. The first repeated pattern 32 of the embodiment 44 comprises a V-shaped cut 46 cut into the first side 28 of the adhesive decal embodiment 44. The V-shaped cut 46 is repeated such that the first repeated pattern 32 forms a half hexagon shape 48 in the first side 28 of the face 26. The second repeated pattern 33 of the second side 30 comprises an up-side-down V-shaped cut 50. The up-side-down V-shaped cut 50 is repeated such that the second repeated pattern 33 forms a half hexagon shape 48 in the second side 30 of the face 26. Embodiment 44 shown in FIG. 5 shows the information display 36 displayed horizontally, thus, embodiment 44 will typically be positioned on one of the horizontal posts 20 of the facemask 12.

FIG. 6 shows an embodiment 52 of the adhesive decal 22. Embodiment 52 is identical to embodiment 44 shown in FIG. 5, but the information display 34 in embodiment 52 is displayed vertically. Thus, embodiment 52 of the adhesive decal 22 will typically be positioned on one of the vertical posts 18 of the facemask 12.

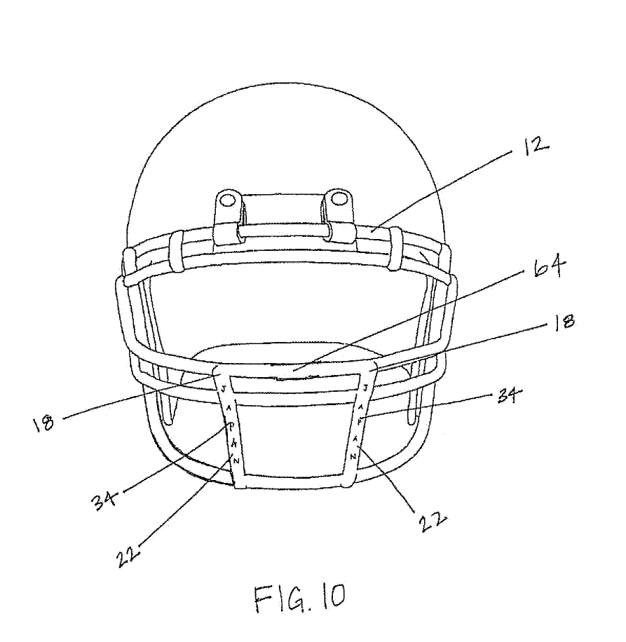

Turning now to FIG. 7, an embodiment 54 of the adhesive decal 22 is shown. The first repeated pattern 32 of the embodiment 54 comprise an alternate V-shaped cut 56 cut into the first side 28 of the adhesive decal embodiment 54. The alternate V-shaped cut 56 comprises a V-cut with a box cut at the deepest part. The alternate V-shaped cut 56 is repeated such that the first repeated pattern 32 forms a half octagon shape 58 in the first side 28 of the face 26. The second repeated pattern 33 of the second side 30 comprises an up-side-down alternate V-shaped cut 60. The up-side-down alternate V-shaped cut 60 is repeated such that the second repeated pattern 33 forms a half octagon shape 58 in the second side 30 of the face 26. Embodiment 62 shown in FIG. 5 shows the information display 34 displayed horizontally; thus, embodiment 54 will typically be positioned on one of the horizontal posts 20 of the facemask 12.

FIG. 8 shows an embodiment 62 of the adhesive decal 22. Embodiment 62 is identical to embodiment 54 shown in FIG. 7, but the information display 34 in embodiment 62 is displayed vertically. Thus, embodiment 62 of the adhesive decal 22 will typically be positioned on one of the vertical posts 18 of the facemask 12.

Turning now to FIG. 10, a front 64 of the posts 16 of the facemask 12 is shown with the adhesive decals 22 on the vertical posts 18. The information display 34 on the adhesive decal 22 in FIG. 10 is displayed vertically as in embodiments 42, 52, and 62. The information display 34 in FIG. 10, as an example, displays the word “Japan” to represent nationality. As discussed, this is just one of many variations of information displays 34 that may be used with the adhesive decal 22. FIG. 11 shows the adhesive decal on the horizontal posts 20 and depicts the horizontal embodiments 36, 44, 54 of the adhesive decal 22. The information display in FIG. 11 depicts a form of advertising for a dental office.

In application, the face 26 containing the information display 34 is adhered to a front 64 of one of the posts 16. The first and second side 28 and 30 of the face 26 are then wrapped around the circumference of the posts 16. The first and second repeated patterns 32 and 33 are cut into the first and second side 28 and 30 allow the first and second side to wrap around and adhere to the circumference of the posts 16 without causing or significantly reducing any dimpling or puckering of the adhesive decal 22. Once wrapped around the circumference of the post 16, the first and second side 28 and 30 of the decals shown in FIGS. 3 and 4 may form in a mating arrangement with each other. The mating arrangement is formed by the first and second side 28 and 30 lying next to and alternating between one another much like the sides of a zipper when zipped. The first and second side 28 and 30 may or may not touch each other when this mating arrangement is formed.

Although the present invention has been described with respect to the preferred embodiment, various changes and modifications may be suggested to one skilled in the art, and it is intended that the present invention encompass such changes and modifications as fall within the scope of this disclosure.

What is claimed is:

1. An adhesive decal for use with a protective helmet comprising a facemask, the facemask comprising a plurality of posts, the adhesive decal comprising
a first side comprising a first repeated pattern;
a second side comprising a second repeated pattern corresponding to the first repeated pattern; and
wherein the adhesive decal is attachable to a circumference of at least one of the plurality of posts of the facemask so that the first repeated pattern is in a mating arrangement with the second repeated pattern.

2. The adhesive decal of claim 1 wherein the repeated patterns are created by removing portions of the adhesive decal from the first side and the second side.

3. The adhesive decal of claim 1 wherein the first repeated pattern is V-shaped.

4. The adhesive decal of claim 1 wherein the first of repeated pattern is U-shaped.

5. The adhesive decal of claim 1 wherein the first of repeated pattern is V-shaped with a box shape at the base of the V.

6. The adhesive decal of claim 1 further comprising a face to display information.

7. The adhesive decal of claim 6 wherein the display information is displayed vertically.

8. The adhesive decal of claim 6 wherein the display information is displayed horizontally.

9. The adhesive decal of claim 1 wherein the first side and the second side touch each other when the adhesive decal adheres to the circumference of the at least one of the plurality of posts of the facemask.

10. An adhesive decal for use with a protective helmet comprising a facemask, the facemask comprising a plurality of posts, the adhesive decal comprising:
a face to display information;
a first side of the face comprising a first repeated pattern;
a second side of the face comprising a second repeated pattern; wherein the first and second repeated patterns are created by removing portions of the adhesive decal from the first side and the second side; and
wherein the adhesive decal is attachable to a circumference of at least one of the plurality of posts of the facemask so that the first repeated pattern is in a mating arrangement with the second repeated pattern.

11. The adhesive decal of claim 10 wherein the first repeated pattern is V-shaped.

12. The adhesive decal of claim 10 wherein the second repeated pattern is U-shaped.

13. The adhesive decal of claim 10 wherein the first of repeated pattern is V-shaped with a box shape at the base of the V.

14. The adhesive decal of claim 10 wherein the display information is displayed vertically.

15. The adhesive decal of claim 10 wherein the display information is displayed horizontally.

16. The adhesive decal of claim 10 wherein the first side and the second side of the face touch each other when the adhesive decal extends around the circumference of the at least one of the plurality of posts of the facemask.

17. A method for adhering an adhesive decal to a protective helmet comprising a facemask, the method comprising the steps of:
cutting a repeated pattern into a first side of the adhesive decal;
cutting a repeated pattern into a second side of the adhesive decal;
adhering the adhesive decal to a circumference of at least one of a plurality of posts of the facemask, wherein the face of the adhesive decal is on a front side of the at least one of the plurality of posts, and wherein the first side and the second side of the face extend around the circumference of the at least one of the plurality of posts.

18. The method of claim 17 wherein the repeated pattern is cut in a V-shape.

19. The method of claim 17 wherein the repeated pattern is cut in a U-shape.

20. The adhesive decal of claim 17 wherein the first of repeated pattern is V-shaped with a box shape at the base of the V.

21. The method of claim 17 wherein the first side and the second side of the decal touch each other when the adhesive decal extends around the circumference of the at least one of the plurality of posts of the facemask.

22. The method of claim 17 further comprising the step of displaying information on the face of the adhesive decal.

23. The method of claim 22 wherein the information is displayed horizontally on the face of the adhesive decal.

24. The method of claim 22 wherein the information is displayed vertically on the face of the adhesive decal.
